(19) United States
(12) Patent Application Publication
(10) Pub. No.: US 2019/0113859 A1
(43) Pub. Date: Apr. 18, 2019

(54) Metallic Toner Carrier

(71) Applicant: Xerox Corporation, Norwalk, CT (US)

(72) Inventors: Elizabeth K. Priebe, Rochester, NY (US); Brian S. Giannetto, Livonia, NY (US); Varun Sambhy, Pittsford, NY (US); Brian E. Moore, Ontario, NY (US); Thomas C. Dombroski, Rochester, NY (US); Juan A. Morales-Tirado, Henrietta, NY (US)

(73) Assignee: Xerox Corporation

(21) Appl. No.: 15/786,031

(22) Filed: Oct. 17, 2017

(51) Int. Cl. G03G 9/113; G03G 9/107

(52) U.S. Cl. CPC G03G 9/1135; G03G 9/1131; G03G 9/1075

(57) ABSTRACT

A carrier including a carrier core; and a coating thereover; wherein the coating comprises a polymer having a low molecular weight of from about 100,000 to about 300,000 g/mole and a particle size of from about 0.05 to about 0.6 micrometer. A developer including a toner; and a carrier; wherein the carrier comprises a carrier core; and a coating thereover; wherein the coating comprises a polymer having a low molecular weight of from about 100,000 to about 300,000 g/mole and a particle size of from about 0.05 to about 0.6 micrometer. A process for preparing a carrier including providing a carrier core; and disposing a polymer coating thereover by combining the carrier core and the polymer coating in a mixing device; optionally, fusing the coating to the carrier core; wherein the coating comprises a polymer having a low molecular weight of from about 100,000 to about 300,000 g/mole and a particle size of from about 0.05 to about 0.6 micrometer.

### BACKGROUND

The present disclosure relates, in various embodiments, to coated carrier particles. More particularly disclosed herein is a carrier comprising a carrier core; and a coating thereover; wherein the coating comprises a polymer having a low molecular weight of from about 100,000 to about 300,000 and a particle size of from about 0.05 to about 0.6 micrometer.

The carriers are suitable for use in developer compositions which are suitable for use in imaging processes such as electrostatographic processes. Further disclosed herein is a developer comprising a toner, in embodiments, a metallic toner; and a carrier; wherein the carrier comprises a carrier core; and a coating thereover; wherein the coating comprises a polymer having a low molecular weight of from about 100,000 to about 300,000 and a particle size of from about 0.05 to about 0.6 micrometer.

Further disclosed is a process for preparing a carrier comprising providing a carrier core; and disposing a polymer coating thereover by combining the carrier core and the polymer coating in a mixing device; optionally, fusing the coating to the carrier core; wherein the coating comprises a polymer having a low molecular weight of from about 100,000 to about 300,000 and a particle size of from about 0.05 to about 0.6 micrometer.

The electrostatographic process, and particularly the xerographic process, is known. This process involves, for example, the formation of an electrostatic latent image on a photoreceptor, followed by development of the image with a developer, and subsequent transfer of the image to a suitable substrate. Numerous different types of xerographic imaging processes are known wherein, for example, insulative developer particles or conductive developer particles are selected depending on the development systems used. Moreover, of interest with respect to the aforementioned developer compositions is the appropriate triboelectric charging values associated therewith, as it is these values that may enable continued formation of developed images of high quality and excellent resolution. In two component developer compositions, carrier particles are used in charging the toner particles.

Carrier particles in part are comprised, for example, of a roughly spherical or irregular shaped core, often referred to as the “carrier core,” that may be generated from a variety of materials or purchased. The core is typically coated with a resin, such as a polymer or copolymer, and which resin may contain a conductive component, such as certain carbon blacks, to, for example, provide carrier particles with more desirable and consistent triboelectric properties.

U.S. Pat. No. 7,419,755, which is hereby incorporated by reference herein in its entirety, describes in the Abstract thereof carrier particles comprising a core and a polymer coating that comprises a mixture of polymethyl methacrylate (PMMA) and melamine The coating compositions comprise from about 60 to about 80 percent by weight of PMMA and from about 20 to about 40 percent by weight of melamine The carriers may be combined with a toner to provide a developer suitable for use in an electrostatographic process. Carriers comprising the PMMA/melamine coatings exhibit increased triboelectric charging, a more conductive carrier, and also contribute to reducing toner cohesion.

A problem encountered with some prior carrier coatings resides in fluctuating triboelectric charging characteristics, particularly with changes in relative humidity. High relative humidity hinders image density in the xerographic process and may cause background deposits, lead to developer instability, and result in an overall degeneration of print quality. Typically, the term “A Zone” refers to hot and humid conditions and the term “C Zone” refers to cold and dry conditions. Triboelectric charges are usually lower in the “A Zone” than in the “C Zone. It is desirable to have the measured triboelectric charges (tribo) for a particular carrier in the A Zone and the C zone, when entered into a ratio of A Zone tribo/C Zone tribo to be close to about 1 to obtain development in high humidity.

Powder coating processes have been used to coat carrier particles. Powder coating processes typically select polymers in the form of fine powders which can be mixed with a carrier core. The triboelectric charging value of the carriers can be controlled by the polymer or mixture of polymers selected for the coating. However, only a limited number of polymers are available or suitable in the form of fine powders, especially for the preparation of conductive carriers. Further, the carrier coating in some instances tends to chip or flake off, and fail upon impact or abrasive contact with machine parts and other carrier particles. These flakes or chips, which cannot usually be readily reclaimed from the developer mixture, have an adverse effect on the triboelectric charging characteristics of the carrier particles, thereby providing images with lower resolution in comparison to those compositions wherein the carrier coatings are retained on the surface of the core substrate. Furthermore, partially coated carriers have a short life, for example, of from about 1 to about 30 days, and poor stability.

A known carrier coating, is polymethyl methacrylate, such as #MP-116 PMMA available from Soken Chemical of Japan. This powder typically has a diameter of about 0.3 to about 0.6 micrometer, and it can be generated from polymethyl methacrylate. Usually, high amounts of PMMA are selected to coat a 30 to 50 micrometer carrier core and achieve a surface area coverage of about 85 to 95 percent on the carrier. The use of such high amounts of carrier coating can result in lower carrier yields because of the formation of fused aggregates. Fused aggregates usually need to be broken up or removed by screening. Crushing or breaking up of the aggregates may result in weak or “chipped off” areas on the carrier surface potentially causing poor coating quality. Screen separation may result in a lower yield as aggregates are removed from the final product.

A PMMA polymer coating on a carrier core is described in U.S. Pat. No. 8,039,183, which is hereby incorporated by reference herein in its entirety.

Carrier particles for use in the development of electrostatic latent images are also described in U.S. Pat. No. 3,590,000, which is hereby incorporated by reference herein in its entirety. These carrier particles may consist of various cores, including steel, with a coating thereover of fluoropolymers and terpolymers of styrene, methacrylate, and silane compounds.

U.S. Pat. No. 4,233,387, which is hereby incorporated by reference herein in its entirety, describes coated carrier components for electrostatographic developer mixtures comprised of finely divided toner particles clinging to the surface of the carrier particles.

U.S. Pat. No. 4,937,166, which is hereby incorporated by reference herein in its entirety, describes a carrier composition comprised of a core with a coating thereover comprised of a mixture of first and second polymers that are not in close proximity thereto in the triboelectric series.

U.S. Pat. No. 4,935,326, which is hereby incorporated by reference herein in its entirety, describes a carrier and developer composition, and a process for the preparation of carrier particles with substantially stable conductivity parameters that comprises (1) providing carrier cores and a polymer mixture; (2) dry mixing the cores and the polymer mixture; (3) heating the carrier core particles and polymer mixture, whereby the polymer mixture melts and fuses to the carrier core particles; and (4) thereafter cooling the resulting coated carrier coated particles.

U.S. Pat. No. 5,567,562, which is hereby incorporated by reference herein in its entirety, describes a process for the preparation of conductive carrier particles which comprises mixing a carrier core with a first polymer pair and a second polymer pair, heating the mixture, and cooling the mixture, wherein the first and second polymer pair each contain an insulating polymer and a conductive polymer, and wherein the carrier conductivity thereof is from about 10⁻⁶ to about 10⁻¹⁴ (ohn-cm)⁻¹.

U.S. Pat. No. 6,042,981, which is hereby incorporated by reference herein in its entirety, describes carriers including a polymer coating wherein the polymer coating may contain a conductive component dispersed in the polymer coating. The conductive component is incorporated into the polymer coating of the carrier core by combining the carrier core, polymer coating, and the conductive component in a mixing process such as cascade roll mixing, tumbling, milling, shaking, electrostatic powder cloud spraying, fluidized bed, electrostatic disc processing, or by an electrostatic curtain. After the mixing process, heating is initiated to coat the carrier core with the polymer coating and conductive component.

Certain metallic toners, such as silver toners, employing carriers can exhibit a low tribo, allowing charge to bleed off too quickly, resulting in print quality defects such as a higher density background.

Currently available carriers are suitable for their intended purposes. However, a need remains for improved carriers having improved ability to hold charge. Further, a need remains for a carrier with high tribo characteristics enabling use of a more conductive toner. Further, a need remains for a higher tribo carrier having magnetic properties and conductivity properties suitable for the desired imaging device. Further, a need remains for a carrier suitable for use with a metallic toner, in embodiments, a silver toner, which carrier is better able to hold charge and which prevents charge from bleeding off too quickly thus avoiding print quality defects such as higher density background. Further, a need remains for an improved process for preparing such carriers.

The appropriate components and process aspects of each of the foregoing U. S. Patents and Patent Publications may be selected for the present disclosure in embodiments thereof. Further, throughout this application, various publications, patents, and published patent applications are referred to by an identifying citation. The disclosures of the publications, patents, and published patent applications referenced in this application are hereby incorporated by reference into the present disclosure to more fully describe the state of the art to which this invention pertains.

### SUMMARY

Described is a carrier comprising a carrier core; and a coating thereover; wherein the coating comprises a polymer having a low molecular weight of from about 100,000 to about 300,000 g/mole and a particle size of from about 0.05 to about 0.6 micrometer.

Also described is a developer comprising a toner; and a carrier; wherein the carrier comprises a carrier core; and a coating thereover; wherein the coating comprises a polymer having a low molecular weight of from about 100,000 to about 300,000 g/mole and a particle size of less than about 1 micrometer, in embodiments, a particle size of from about 0.05 to about 0.6 micrometer.

Also described is a process for preparing a carrier comprising providing a carrier core; and disposing a polymer coating thereover by combining the carrier core and the polymer coating in a mixing device; optionally, fusing the coating to the carrier core; wherein the coating comprises a polymer having a low molecular weight of from about 100,000 to about 300,000 g/mole and a particle size of from about 0.05 to about 0.6 micrometer.

### BRIEF DESCRIPTION OF THE DRAWINGS

FIG. 1 is a graph showing triboelectric charging performance (y-axis, microCoulombs/gram) for various carriers (x-axis).

### DETAILED DESCRIPTION

The present disclosure provides a carrier comprising a carrier core and a coating thereover; wherein the coating comprises a polymer having a low molecular weight of from about 100,000 to about 300,000 g/mole and a particle size of from about 0.05 to about 0.6 micrometer.

Also provided is a developer comprising a toner; and a carrier; wherein the carrier comprises a carrier core; and a coating thereover; wherein the coating comprises a polymer having a low molecular weight of from about 100,000 to about 300,000 g/mole and a particle size of from about 0.05 to about 0.6 micrometer.

Also provided is a process for preparing a carrier comprising providing a carrier core; and disposing a polymer coating thereover by combining the carrier core and the polymer coating in a mixing device; optionally, fusing the coating to the carrier core; wherein the coating comprises a polymer having a low molecular weight of from about 100,000 to about 300,000 g/mole and a particle size of from about 0.05 to about 0.6 micrometer.

Carrier Core.

The core preferably possesses properties that enable the toner particles to acquire a positive charge or a negative charge, and that will permit flow properties in the developer reservoir present in the xerographic imaging apparatus. Other carrier core properties that may be considered in selecting the core material include suitable magnetic characteristics that will permit magnetic brush formation in magnetic brush development processes. The core preferably possesses desirable mechanical aging characteristics.

In embodiments, carrier core particles are selected for mixing with a toner composition such that the core particles are capable of triboelectrically obtaining a charge of opposite polarity to that of the toner particles.

The core particle can be selected from any suitable or desired carrier core material. In embodiments, the carrier core is selected from the group consisting of granular zircon, granular silicon, glass, iron, steel, iron ferrites, magnetites, nickel, silicon dioxide, and mixtures thereof. The carrier particles can be nickel berry carriers, comprised of nodular carrier beads of nickel, characterized by surfaces of reoccurring recesses and protrusions thereby providing particles with a relatively large external area. In certain embodiments, the carrier core is selected from the group consisting of iron, steel, ferrites, magnetites, nickel, and mixtures thereof. In embodiments, the carrier core is magnetite. In a specific embodiment, the carrier core is steel.

The carrier core particle may have any suitable or desired shape or size.

Average particle or drop size is typically represented as D50 or d₅₀, or defined as the volume median particle size value at the 50th percentile of the particle size distribution, wherein 50% of the particles in the distribution are greater than the d₅₀ particle size value, and the other 50% of the particles in the distribution are less than the d₅₀ value. Average particle size can be measured by methods that use light scattering technology to infer particle size, such as Dynamic Light Scattering. The particle diameter refers to the length of an individual drop of the discontinuous layer as derived from images of the particles generated by Transmission Electron Microscopy or from Dynamic Light Scattering measurements.

In embodiments, a carrier core having an average diameter of, for example, about 5 micrometers to about 100 micrometers may be used. In embodiments, the carrier core is a substantially spherical particle having an average particle diameter (such as particle diameter or longest dimension), in embodiments, volume average D50 as measured by laser diffraction, of from about 50 to about 90 micrometers, as determined by standard laser diffraction techniques. In embodiments, the core particles have an average diameter (D50) of from about 60 to about 90 micrometers, or from about 75 to about 85 micrometers.

In embodiments, a carrier core having an average diameter of from about 60 to about 90 micrometers is selected.

In embodiments, the core particles may individually have a magnetic saturation of 180 to 200 emu/g, a coercivity of 20 to 30 Oer, and a retentivity of 1.0 to 5.0 emu/g.

In embodiments, steel core particles may have a powder density as determined by ASTM Test B-202-99 of 2.70 to 2.95 g/cm³, a conductivity of 1.5×10⁻⁶ to 2.5×10⁻⁹ (ohm cm)⁻¹, and a breakdown voltage of 30 to 60V. The conductivity of the core is measured by applying a 10V fixed voltage across a 0.1 inch magnetic brush in a static (non-rotating) mode. The resultant current flow through the material is used to calculate the conductivity of the core. The voltage breakdown of the core is measured by applying a fixed rate of increasing voltage across 0.1 inch magnetic brush while under rotation. The applied voltage at which 100 microamps of current flows through the samples is defined as the breakdown voltage.

Carrier Coating.

The carrier core has a coating disposed thereover wherein the coating comprises a polymer having a low molecular weight of from about 100,000 to about 300,000 g/mole, or from about 100,000 to about 200,000 g/mole, or from about 125,000 to about 175,000 g/mole, and a particle size of from about 0.05 to about 0.6 micrometer, from about 0.07 to about 0.3 micrometer, or from about 0.1 to about 0.25 micrometer. In a specific embodiment, the carrier core has a coating disposed thereover wherein the coating comprises a polymer having a low molecular weight of from about 125,000 to about 175,000 g/mole and a particle size of from about 0.1 to about 0.25 micrometer.

Mw (weight-average molecular weight) was determined by dissolving the polymer sample in tetrahydrofuran (THF) and analyzing the THF soluble portion by Gel Permeation Chromatography. The measured parameter is hydrodynamic volume which is compared to hydrodynamic volume of polystyrene standards. The instrument was calibrated using styrene standards and molecular weight is reported in “pse” (polystyrene equivalents).

Any suitable or desired polymer can be selected provided the polymer possesses the characteristics of having the low molecular weight in combination with the particle size described herein.

In embodiments, the carrier coating is selected from the group consisting of fluoropolymers, such as polyvinylidene fluoride resins, terpolymers of styrene, methyl methacrylate, a silane, such as triethoxy silane, tetrafluorethylenes, other known coatings, and the like. In embodiments, the carrier coating is selected from the group consisting of polymethyl methacrylate, copoly-trifluoroethyl-methacrylate-methyl methacrylate, polyvinylidene fluoride, polyvinylfluoride copolybutylacrylate methacrylate, copoly perfluorooctylethylmethacrylate methylmethacrylate, polystyrene, a copolymer of trifluoroethyl-methacrylate and methylmethacrylate, in embodiments containing a sodium dodecyl sulfate surfactant, and combinations thereof. The coating may include additives such as a conductive additive, for example carbon black.

In embodiments, the carrier coating is a PMMA material comprising polymethyl methacrylate, such as #MP-116 PMMA available from Soken Chemical of Japan.

In embodiments, the carrier core is coated with a polymethyl methacrylate (PMMA) polymer having a low molecular weight and a small particle size. In embodiments, the carrier core is coated with a polymethyl methacrylate (PMMA) polymer having a low molecular weight, in embodiments a weight average molecular weight, of from about 100,000 to about 300,000 g/mole, or from about 100,000 to about 200,000 g/mole, or from about 125,000 to about 175,000 g/mole, in combination with a small particle size of from about 0.05 to about 0.6 micrometer, or from about 0.07 to about 0.3 micrometer, or from about 0.1 to about 0.25 micrometer. In embodiments, the carrier core is coated with a polymethyl methacrylate (PMMA) polymer having a low molecular weight, in embodiments a weight average molecular weight, of from about 125,000 to about 175,000 g/mole, and a particle size of from about 0.1 to about 0.25 micrometer.

In embodiments, the polymer coating of the carrier core comprises PMMA having, in combination, a low weight average molecular weight of from about 100,000 to about 300,000 g/mole and an average particle size as determined by Scanning Electron Micrography of less than 1 micrometer. In embodiments, the coating polymer is polymethyl methacrylate having a low molecular weight of from about 100,000 to about 200,000 g/mole and an average particle size of less than about 0.6 micrometer. In embodiments, the polymer coating of the carrier core comprises PMMA having, in combination, a low weight average molecular weight of from about 125,000 to about 175,000 g/mole and an average particle size as determined by Scanning Electron Micrography of less than 0.5 micrometer.

In embodiments, the carrier core comprises a steel core and the coating thereover comprises a polymethyl methacrylate having a low molecular weight of from about 100,000 to about 300,000 g/mole and an average particle size of less than about 1 micrometer.

In certain embodiments, the carrier core comprises a steel core and a coating thereover comprising a PMMA having, in combination, a low weight average molecular weight of from about 125,000 to about 175,000 g/mole and an average particle size as determined by Scanning Electron Micrography of less than 1 micrometer, or, in embodiments, less than 0.5 micrometer, or less than about 0.3 micrometer.

In embodiments, the PMMA may be an electropositive polymer in that the polymer will generally impart a negative charge on the toner with which it is contacted.

The PMMA may optionally be copolymerized with any desired comonomer provided the resulting copolymer retains the weight average molecular weight and particle size described herein. Suitable comonomers may include monoalkyl or dialkyl amines, such as dimethylaminoethyl methacrylate, diethylaminoethyl methacrylate, diisopropylaminoethyl methacrylate, or t-butylaminoethyl methacrylate, and the like.

In embodiments the polymer coating of the carrier core is applied in dry powder form, applied, such as melted and fused, to the carrier core at higher temperatures on the order of about 220° C. to about 260° C. Temperatures above 260° C. may adversely degrade the PMMA. Triboelectric tunability of the carrier and developers herein may be provided by the temperature at which the carrier coating may be applied, higher temperatures resulting in higher tribo up to a point beyond which increasing temperature acts to degrade the polymer coating and thus lower tribo.

The carrier coating may be provided over the carrier core at any suitable or desired coating weight. In embodiments, the polymer coating coverage may be from about 30 percent to about 100 percent of the surface area of the carrier core with a 0.1 percent to about a 4 percent coating weight. In embodiments, about 75 percent to about 98 percent of the core surface area is covered with the polymer coating, in embodiments, by using about 0.3 percent to about 1.5 percent coating weight. The use of smaller sized coating powers may be advantageous as a smaller amount by weight of the coating may be selected to sufficiently coat a carrier core. The use of smaller particle sized coating powders also enables the formation of thinner coatings. Using less coating is cost effective and results in less coating amount separating form the carrier to interfere with the triboelectric charging characteristics of the toner and/or developer.

In embodiments, the carrier core is provided with a coating thereoever as described herein provided at a coating weight of from about 0.5 pph to about 1.5 pph, [pph=parts per hundred. 1.0 pph=1 gram of coating per 100 grams of core], or from about 0.8 to about 1.2 pph. In specific embodiments, the carrier core is provided with a coating thereoever as described herein provided at a coating weight of from about 0.8 pph to about 1.2 pph of coating formulation.

The carrier coating may be applied to the surface of the carrier core particles by any suitable or desired process. In embodiments, the process comprises combining the carrier core material and the carrier coating by cascade roll mixing, tumbling, milling, shaking, electrostatic powder cloud spraying, fluidized bed, electrostatic disc processing, or using an electrostatic curtain. Following application of the carrier coating to the carrier core, heating may be initiated to permit flowout of the coating material over the surface of the carrier core. The concentration of the coating material powder particles, as well as the parameters of the heating step, may be selected to enable the formation of a continuous film of the coating material on the surface of the carrier core, or permit only selected areas of the carrier core to be coated. When selected areas of the carrier core remain uncoated or exposed, the carrier particles will possess electrically conductive properties when the core material comprises a metal. For example, a mixture of a carrier core particle and a PMMA coating having the combination of low molecular weight and particle size described herein may be heated to a temperature of from about 200° F. to about 650° F. for any suitable or desired period of time, such as for about 10 minutes to about 60 minutes, enabling the PMMA to melt and fuse to the carrier core particles. The coated carrier particles can then be cooled and thereafter classified to a desired particle size.

Thus, in embodiments, an oven temperature is selected to enable the material being heated to reach a desired temperature. For instance, as provided in the examples, the oven temperature was set to 450° F. (232° C.) and the processed material reached a temperature of 395 to 437° F. (202 to 225° C.). Thus, in embodiments, an oven temperature of from about 400 to about 475° F. (204 to 246° C.) is selected to heat the product (material to be heated) to a range of from about 390 to about 440° F. (199° C. to 227° C.). Thus, oven temperature is a controlled variable to achieve a product temperature in a desired range to enable the coating to possess desired flow property and to cover the desired amount of the surface, etc.

In embodiments, a process for preparing a carrier comprises providing a carrier core; and disposing a polymer coating thereover by combining the carrier core and the polymer coating in a mixing device; optionally, fusing the coating to the carrier core; wherein the coating comprises a polymer having a low molecular weight of from about 100,000 to about 300,000 g/mole and a particle size of from about 0.05 to about 0.3 micrometer.

Any suitable or desired device may be selected for combining the carrier core and coating, for example, a Littleford M5R Jacketed Mixer. In embodiments, a jacketed mixer such as the M5R mixer available from Littleford Corporation, is used, with blend batch size selected to fill between 30 and 60% of the blender before blending.

In embodiments, combining the carrier core and the polymer coating in the mixing device is accomplished using mixing of from about 100 to about 420 revolutions per minute, or from about 150 to about 300 revolutions per minute, or from about 175 to about 250 revolutions per minute, in a mixing device such as an M5R Jacketed Mixer available from Littleford Corporation. In certain embodiments, combining the carrier core and the polymer coating in the mixing device is accomplished using mixing of from about 175 to about 250 revolutions per minute, for any suitable or desired length of time, in embodiments, for a period of from about 5 to about 30 minutes.

In embodiments, combining the carrier core and the polymer coating in the mixing device is accomplished using high intensity mixing of from about 300 to about 450 revolutions per minute, medium intensity mixing of from about 150 to about 250 revolutions per minute, or a combination thereof. In certain embodiments, combining the carrier core and the polymer coating in the mixing device is accomplished using high intensity mixing of from about 300 to about 450 revolutions per minute.

Without wishing to be bound by theory, it is believed that the use of high intensity mixing as described herein results in improved adhesion of the coating polymer to the core surface and more complete coverage of the core surface by the coating polymer.

Developer.

A developer herein comprises comprising a toner; and a carrier; wherein the carrier comprises a carrier core; and a coating thereover; wherein the coating comprises a polymer having a low molecular weight of from about 100,000 to about 300,000 g/mole and a particle size of less than about 1 micrometer, in embodiments, a particle size of from about 0.05 to about 0.6 micrometer.

Developer compositions may be prepared by combining a carrier as described herein with a toner. Any suitable or desired toner can be selected as desired for a particular purpose or intended use. In embodiments, a metallic toner is selected.

The toner can be any suitable or desired toner including conventional toner prepared by mechanical grinding processes and chemical toner prepared by chemical processes such as emulsion aggregation and suspension polymerization.

The toner may comprise any suitable or desired components. In embodiments, the toner may comprise one or more of a resin, a wax, a colorant, additives, and the like.

Toner Resin.

Any suitable or desired resin can be selected for the toner particles. Suitable resins include amorphous low molecular weight linear polyesters, high molecular weight branched and crosslinked polyesters and crystalline polyesters. In embodiments, the polymer utilized to form the resin core may be a polyester resin, including the resins described in U.S. Pat. Nos. 6,593,049 and 6,756,176, the disclosures of each of which are hereby incorporated by reference in their entirety. Suitable resins may also include a mixture of an amorphous polyester resin and a crystalline polyester resin as described in U.S. Pat. No. 6,830,860, the disclosure of which is hereby incorporated by reference in its entirety.

In embodiments, the resin may be a polyester resin formed by reacting a diol with a diacid in the presence of an optional catalyst. For forming a crystalline polyester, suitable organic diols include aliphatic diols with from about 2 to about 36 carbon atoms, such as 1,2-ethanediol, 1,3-propanediol, 1,4-butanediol, 1,5-pentanediol, 1,6-hexanediol, 1,7-heptanediol, 1,8-octanediol, 1,9-nonanediol, 1,10-decanediol, 1,12-dodecanediol and the like; alkali sulfo-aliphatic diols such as sodio 2-sulfo-1,2-ethanediol, lithio 2-sulfo-1,2-ethanediol, potassio 2-sulfo-1,2-ethanediol, sodio 2-sulfo-1,3-propanediol, lithio 2-sulfo-1,3-propanediol, potassio 2-sulfo-1,3-propanediol, mixtures thereof, and the like. The aliphatic diol may be, for example, selected in an amount of from about 40 to about 60 mole percent, in embodiments from about 42 to about 55 mole percent, in embodiments from about 45 to about 53 mole percent, and the alkali sulfo-aliphatic diol can be selected in an amount of from about 0 to about 10 mole percent, in embodiments from about 1 to about 4 mole percent of the resin.

Examples of organic diacids or diesters including vinyl diacids or vinyl diesters selected for the preparation of the crystalline resins include oxalic acid, malonic acid, succinic acid, glutaric acid, adipic acid, pimelic acid, suberic acid, azelaic acid, sebacic acid, undecanedioic acid, dodecanedioic acid, 1,11-undecane dicarboxylic acid, 1,12-dodecane dicarboxylic acid, 1,13-tridecane dicarboxylic acid, 1,14-tetradecane dicarboxylic acid, fumaric acid, dimethyl fumarate, dimethyl itaconate, cis-1,4-diacetoxy-2-butene, diethyl fumarate, diethyl maleate, phthalic acid, isophthalic acid, terephthalic acid, naphthalene-2,6-dicarboxylic acid, naphthalene-2,7-dicarboxylic acid, cyclohexane dicarboxylic acid, malonic acid and mesaconic acid, a diester or anhydride thereof; and an alkali sulfo-organic diacid such as the sodio, lithio or potassio salt of dimethyl-5-sulfo-isophthalate, dialkyl-5-sulfo-isophthalate-4-sulfo-1,8-naphthalic anhydride, 4-sulfo-phthalic acid, dimethyl-4-sulfo-phthalate, dialkyl-4-sulfo-phthalate, 4-sulfophenyl-3,5-dicarbomethoxybenzene, 6-sulfo-2-naphthyl-3,5-dicarbomethoxybenzene, sulfo-terephthalic acid, dimethyl-sulfo-terephthalate, 5-sulfo-isophthalic acid, dialkyl-sulfo-terephthalate, sulfoethanediol, 2-sulfopropanediol, 2-sulfobutanediol, 3-sulfopentanediol, 2-sulfohexanediol, 3-sulfo-2-methylpentanediol, 2-sulfo-3,3-dimethylpentanediol, sulfo-p-hydroxybenzoic acid, N,N-bis(2-hydroxyethyl)-2-amino ethane sulfonate, or mixtures thereof. The organic diacid may be selected in an amount of, for example, in embodiments from about 40 to about 60 mole percent, in embodiments from about 42 to about 52 mole percent, in embodiments from about 45 to about 50 mole percent, and the alkali sulfo-aliphatic diacid can be selected in an amount of from about 1 to about 10 mole percent of the resin.

Examples of crystalline resins include polyesters, polyamides, polyimides, polyolefins, polyethylene, polybutylene, polyisobutyrate, ethylene-propylene copolymers, ethylene-vinyl acetate copolymers, polypropylene, mixtures thereof, and the like. Specific crystalline resins may be polyester based, such as poly(ethylene-adipate), poly(propylene-adipate), poly(butylene-adipate), poly(pentylene-adipate), poly(hexylene-adipate), poly(octylene-adipate), poly(nonylene-adipate), poly(decylene-adipate), poly(undecylene-adipate), poly(dodecylene-adipate), poly(ethylene-succinate), poly(propylene-succinate), poly(butylene-succinate), poly(pentylene-succinate), poly(hexylene-succinate), poly(octylene-succinate), poly(nonylene-succinate), poly(decylene-succinate), poly(undecylene-succinate), poly(dodecylene-succinate), poly(ethylene-sebacate), poly(propylene-sebacate), poly(butylene-sebacate), poly(pentylene-sebacate), poly(hexylene-sebacate), poly(octylene-sebacate), poly(nonylene-sebacate), poly(decylene-sebacate), poly(undecylene-sebacate), poly(dodecylene-sebacate), poly(ethylene-dodecanedioate), poly(propylene-dodecanedioate), poly(butylene-dodecanedioate), poly(pentylene-dodecanedioate), poly(hexylene-dodecanedioate), poly(octylene-dodecanedioate), poly(nonylene-dodecandioate), poly(decylene-dodecandioate), poly(undecylene-dodecandioate), poly(dodecylene-dodecandioate), poly(ethylene-fumarate), poly(propylene-fumarate), poly(butylene-fumarate), poly(pentylene-fumarate), poly(hexylene-fumarate), poly(octylene-fumarate), poly(nonylene-fumarate), poly(decylene-fumarate), copolymers such as copoly(ethylene-fumarate)-copoly(ethylene-dodecandioate) and the like, alkali copoly(5-sulfoisophthaloyl)-copoly(ethylene-adipate), alkali copoly(5-sulfoisophthaloyl)-copoly(propylene-adipate), alkali copoly(5-sulfoisophthaloyl)-copoly(butylene-adipate), alkali copoly(5-sulfo-isophthaloyl)-copoly(pentylene-adipate), alkali copoly(5-sulfo-isophthaloyl)-copoly(hexylene-adipate), alkali copoly(5-sulfo-isophthaloyl)-copoly(octylene-adipate), alkali copoly(5-sulfo-isophthaloyl)-copoly(ethylene-adipate), alkali copoly(5-sulfo-isophthaloyl)-copoly (propylene-adipate), alkali copoly(5-sulfo-isophthaloyl)-copoly(butylene-adipate), alkali copoly(5-sulfo-isophthaloyl)-copoly(pentylene-adipate), alkali copoly(5-sulfo-isophthaloyl)-copoly(hexylene-adipate), alkali copoly(5-sulfo-isophthaloyl)-copoly(octylene-adipate), alkali copoly(5-sulfoisophthaloyl)-copoly(ethylene-succinate), alkali copoly(5-sulfoisophthaloyl)-copoly(propylene-succinate), alkali copoly(5-sulfoisophthaloyl)-copoly(butylenes-succinate), alkali copoly(5-sulfoisophthaloyl)-copoly(pentylene-succinate), alkali copoly(5-sulfoisophthaloyl)-copoly(hexylene-succinate), alkali copoly(5-sulfoisophthaloyl)-copoly(octylene-succinate), alkali copoly(5-sulfo-isophthaloyl)-copoly(ethylene-sebacate), alkali copoly(5-sulfo-isophthaloyl)-copoly(propylene-sebacate), alkali copoly(5-sulfo-isophthaloyl)-copoly(butylene-sebacate), alkali copoly(5-sulfo-isophthaloyl)-copoly(pentylene-sebacate), alkali copoly(5-sulfo-isophthaloyl)-copoly(hexylene-sebacate), alkali copoly(5-sulfo-isophthaloyl)-copoly(octylene-sebacate), alkali copoly(5-sulfo-isophthaloyl)-copoly(ethylene-adipate), alkali copoly(5-sulfo-isophthaloyl)-copoly(propylene-adipate), alkali copoly(5-sulfo-isophthaloyl)-copoly(butylene-adipate), alkali copoly(5-sulfo-isophthaloyl)-copoly(pentylene-adipate), alkali copoly(5-sulfo-isophthaloyl)-copoly(hexylene-adipate), wherein alkali is a metal like sodium, lithium or potassium. Examples of polyamides include poly(ethylene-adipamide), poly(propylene-adipamide), poly(butylenes-adipamide), poly(pentylene-adipamide), poly(hexylene-adipamide), poly(octylene-adipamide), poly(ethylene-succinamide), and poly(propylene-sebecamide). Examples of polyimides include poly(ethylene-adipimide), poly(propylene-adipimide), poly(butylene-adipimide), poly(pentylene-adipimide), poly(hexylene-adipimide), poly(octylene-adipimide), poly(ethylene-succinimide), poly(propylene-succinimide), and poly(butylene-succinimide).

The crystalline resin may be present, for example, in an amount of from about 5 to about 50 percent by weight of the toner components, in embodiments from about 5 to about 35 percent by weight of the toner components. The crystalline resin can possess various melting points of, for example, from about 30° C. to about 120° C., in embodiments from about 50° C. to about 90° C. The crystalline resin may have a number average molecular weight (Mn), as measured by gel permeation chromatography (GPC) of, for example, from about 1,000 to about 50,000, in embodiments from about 2,000 to about 25,000, and a weight average molecular weight (Mw) of, for example, from about 2,000 to about 100,000, in embodiments from about 3,000 to about 80,000, as determined by Gel Permeation Chromatography using polystyrene standards. The molecular weight distribution (Mw/Mn) of the crystalline resin may be, for example, from about 2 to about 6, in embodiments from about 2 to about 4.

Examples of diacid or diesters including vinyl diacids or vinyl diesters selected for the preparation of amorphous polyesters include dicarboxylic acids or diesters such as terephthalic acid, phthalic acid, isophthalic acid, fumaric acid, dimethyl fumarate, dimethyl itaconate, cis-1,4-diacetoxy-2-butene, diethyl fumarate, diethyl maleate, maleic acid, succinic acid, itaconic acid, succinic anhydride, dodecylsuccinic acid, dodecylsuccinic anhydride, dodecenylsuccinic acid, dodecenylsuccinic anhydride, glutaric acid, glutaric anhydride, adipic acid, pimelic acid, suberic acid, azelaic acid, dodecane diacid, dimethyl terephthalate, diethyl terephthalate, dimethylisophthalate, diethylisophthalate, dimethylphthalate, phthalic anhydride, diethylphthalate, dimethylsuccinate, dimethylfumarate, dimethylmaleate, dimethylglutarate, dimethyladipate, dimethyl dodecylsuccinate, and combinations thereof. The organic diacid or diester may be present, for example, in an amount from about 40 to about 60 mole percent of the resin, in embodiments from about 42 to about 52 mole percent of the resin, in embodiments from about 45 to about 50 mole percent of the resin.

Examples of diols utilized in generating the amorphous polyester include 1,2-propanediol, 1,3-propanediol, 1,2-butanediol, 1,3-butanediol, 1,4-butanediol, pentanediol, hexanediol, 2,2-dimethylpropanediol, 2,2,3-trimethylhexanediol, heptanediol, dodecanediol, bis(hydroxyethyl)-bisphenol A, bis(2-hydroxypropyl)-bisphenol A, 1,4-cyclohexanedimethanol, 1,3-cyclohexanedimethanol, xylenedimethanol, cyclohexanediol, diethylene glycol, bis(2-hydroxyethyl) oxide, dipropylene glycol, dibutylene, and combinations thereof. The amount of organic diol selected can vary, and may be present, for example, in an amount from about 40 to about 60 mole percent of the resin, in embodiments from about 42 to about 55 mole percent of the resin, in embodiments from about 45 to about 53 mole percent of the resin.

In embodiments, the resin may be formed by condensation polymerization methods. Polycondensation catalysts which may be utilized for either the crystalline or amorphous polyesters include tetraalkyl titanates, dialkyltin oxides such as dibutyltin oxide, tetraalkyltins such as dibutyltin dilaurate, and dialkyltin oxide hydroxides such as butyltin oxide hydroxide, aluminum alkoxides, alkyl zinc, dialkyl zinc, zinc oxide, stannous oxide, or combinations thereof. Such catalysts may be utilized in amounts of, for example, from about 0.01 mole percent to about 5 mole percent based on the starting diacid or diester used to generate the polyester resin.

In embodiments, the polyester resin may be a saturated or unsaturated amorphous polyester resin. Illustrative examples of saturated and unsaturated amorphous polyester resins selected for the process and particles of the present disclosure include any of the various amorphous polyesters, such as polyethylene-terephthalate, polypropylene-terephthalate, polybutylene-terephthalate, polypentylene-terephthalate, polyhexalene-terephthalate, polyheptadene-terephthalate, polyoctalene-terephthalate, polyethylene-isophthalate, polypropylene-isophthalate, polybutylene-isophthalate, polypentylene-isophthalate, polyhexalene-isophthalate, polyheptadene-isophthalate, polyoctalene-isophthalate, polyethylene-sebacate, polypropylene sebacate, polybutylene-sebacate, polyethylene-adipate, polypropylene-adipate, polybutylene-adipate, polypentylene-adipate, polyhexalene-adipate, polyheptadene-adipate, polyoctalene-adipate, polyethylene-glutarate, polypropylene-glutarate, polybutylene-glutarate, polypentylene-glutarate, polyhexalene-glutarate, polyheptadene-glutarate, polyoctalene-glutarate polyethylene-pimelate, polypropylene-pimelate, polybutylene-pimelate, polypentylene-pimelate, polyhexalene-pimelate, polyheptadene-pimelate, poly(ethoxylated bisphenol A-fumarate), poly(ethoxylated bisphenol A-succinate), poly(ethoxylated bisphenol A-adipate), poly(ethoxylated bisphenol A-glutarate), poly(ethoxylated bisphenol A-terephthalate), poly(ethoxylated bisphenol A-isophthalate), poly(ethoxylated bisphenol A-dodecenylsuccinate), poly(propoxylated bisphenol A-fumarate), poly(propoxylated bisphenol A-succinate), poly(propoxylated bisphenol A-adipate), poly(propoxylated bisphenol A-glutarate), poly(propoxylated bisphenol A-terephthalate), poly(propoxylated bisphenol A-isophthalate), poly(propoxylated bisphenol A-dodecenylsuccinate), SPAR (Dixie Chemicals), BECKOSOL (Reichhold Inc), ARAKOTE (Ciba-Geigy Corporation), HETRON (Ashland Chemical), PARAPLEX (Rohm & Haas), POLYLITE (Reichhold Inc), PLASTHALL (Rohm & Haas), CYGAL (American Cyanamide), ARMCO (Armco Composites), ARPOL (Ashland Chemical), CELANEX (Celanese Eng), RYNITE (DuPont), STYPOL (Freeman Chemical Corporation) and combinations thereof. The resins can also be functionalized, such as carboxylated, sulfonated, or the like, and particularly such as sodio sulfonated, if desired.

In embodiments, an unsaturated polyester resin may be utilized as a latex resin. Examples of such resins include those disclosed in U.S. Pat. No. 6,063,827, the disclosure of which is hereby incorporated by reference in its entirety. Exemplary unsaturated amorphous polyester resins include, but are not limited to, poly(propoxylated bisphenol A co-fumarate), poly(ethoxylated bisphenol A co-fumarate), poly(butyloxylated bisphenol A co-fumarate), poly(co-propoxylated bisphenol A co-ethoxylated bisphenol A co-fumarate), poly(1,2-propylene fumarate), poly(propoxylated bisphenol A co-maleate), poly(ethoxylated bisphenol A co-maleate), poly(butyloxylated bisphenol A co-maleate), poly(co-propoxylated bisphenol A co-ethoxylated bisphenol A co-maleate), poly(1,2-propylene maleate), poly(propoxylated bisphenol A co-itaconate), poly(ethoxylated bisphenol A co-itaconate), poly(butyloxylated bisphenol A co-itaconate), poly(co-propoxylated bisphenol A co-ethoxylated bisphenol A co-itaconate), poly(1,2-propylene itaconate), and combinations thereof.

In embodiments, a suitable linear amorphous polyester resin may be a poly(propoxylated bisphenol A co-fumarate) resin having the following formula (I):

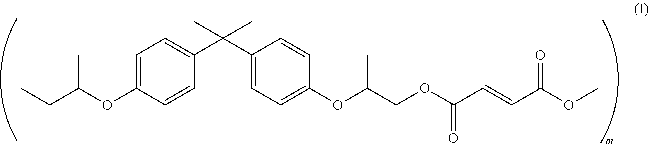

wherein m may be from about 5 to about 1000.

An example of a linear amorphous propoxylated bisphenol A fumarate resin which may be utilized as a latex resin is available under the trade name SPARIITM from Resana S/A Industrias Quimicas, Sao Paulo Brazil. Other suitable linear amorphous resins include those disclosed in U.S. Pat. Nos. 4,533,614, 4,957,774 and 4,533,614, which can be linear polyester resins including dodecylsuccinic anhydride, terephthalic acid, and alkyloxylated bisphenol A. Other alkoxylated bisphenol A terephthalate resins that may be utilized and are commercially available include GTU-FC115, commercially available from Kao Corporation, Japan, and the like.

Suitable crystalline resins include those disclosed in U.S. Pat. No. 7,329,476, U.S. Patent. Application Publication Nos. 2006/0216626, 2008/0107990, 2008/0236446, and 2009/0047593 the disclosure of each of which is hereby incorporated by reference in its entirety. In embodiments, a suitable crystalline resin may include a resin composed of ethylene glycol and a mixture of dodecanedioic acid and fumaric acid co-monomers with the following formula:

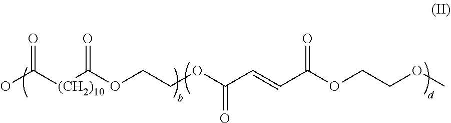

wherein b is from 5 to 2000 and d is from 5 to 2000.

For example, in embodiments, a poly(propoxylated bisphenol A co-fumarate) resin of formula I as described above may be combined with a crystalline resin of formula II to form a core.

In embodiments, the amorphous resin or combination of amorphous resins utilized in the core may have a glass transition temperature of from about 30° C. to about 80° C., in embodiments from about 35° C. to about 70° C. In further embodiments, the combined resins utilized in the core may have a melt viscosity of from about 10 to about 1,000,000 Pa*S at about 130° C., in embodiments from about 50 to about 100,000 Pa*S.

One, two, or more toner resins may be used. In embodiments where two or more toner resins are used, the toner resins may be in any suitable ratio (e.g., weight ratio) such as for instance about 10% (first resin)/90% (second resin) to about 90% (first resin)/10% (second resin).

In one embodiment, the amorphous polyester resin is present in an amount of from about 50% to about 85% by weight based upon the total weight of the toner.

Additional exemplary polymers include styrene acrylates, styrene butadienes, styrene methacrylates, and more specifically, poly(styrene-alkyl acrylate), poly(styrene-1,3-diene), poly(styrene-alkyl methacrylate), poly (styrene-alkyl acrylate-acrylic acid), poly(styrene-1,3-diene-acrylic acid), poly (styrene-alkyl methacrylate-acrylic acid), poly(alkyl methacrylate-alkyl acrylate), poly(alkyl methacrylate-aryl acrylate), poly(aryl methacrylate-alkyl acrylate), poly(alkyl methacrylate-acrylic acid), poly(styrene-alkyl acrylate-acrylonitrile-acrylic acid), poly (styrene-1,3-diene-acrylonitrile-acrylic acid), poly(alkyl acrylate-acrylonitrile-acrylic acid), poly(styrene-butadiene), poly(methylstyrene-butadiene), poly(methyl methacrylate-butadiene), poly(ethyl methacrylate-butadiene), poly(propyl methacrylate-butadiene), poly(butyl methacrylate-butadiene), poly(methyl acrylate-butadiene), poly(ethyl acrylate-butadiene), poly(propyl acrylate-butadiene), poly(butyl acrylate-butadiene), poly(styrene-isoprene), poly(methylstyrene-isoprene), poly (methyl methacrylate-isoprene), poly(ethyl methacrylate-isoprene), poly(propyl methacrylate-isoprene), poly(butyl methacrylate-isoprene), poly(methyl acrylate-isoprene), poly(ethyl acrylate-isoprene), poly(propyl acrylate-isoprene), poly(butyl acrylate-isoprene), poly(styrene-propyl acrylate), poly(styrene-butyl acrylate), poly (styrene-butadiene-acrylic acid), poly(styrene-butadiene-methacrylic acid), poly (styrene-butadiene-acrylonitrile-acrylic acid), poly(styrene-butyl acrylate-acrylic acid), poly(styrene-butyl acrylate-methacrylic acid), poly(styrene-butyl acrylate-acrylononitrile), poly(styrene-butyl acrylate-acrylonitrile-acrylic acid), poly(styrene-butadiene), poly(styrene-isoprene), poly(styrene-butyl methacrylate), poly(styrene-butyl acrylate-acrylic acid), poly(styrene-butyl methacrylate-acrylic acid), poly(butyl methacrylate-butyl acrylate), poly(butyl methacrylate-acrylic acid), poly(acrylonitrile-butyl acrylate-acrylic acid), and combinations thereof. The polymers may be block, random, or alternating copolymers.

In embodiments, the resin is selected from the group consisting of styrenes, acrylates, methacrylates, butadienes, isoprenes, acrylic acids, methacrylic acids, acrylonitriles, and combinations thereof.

In certain embodiments, the resin is selected from the group consisting of poly(styrene-butadiene), poly(methyl methacrylate-butadiene), poly(ethyl methacrylate-butadiene), poly(propyl methacrylate-butadiene), poly(butyl methacrylate-butadiene), poly(methyl acrylate-butadiene), poly(ethyl acrylate-butadiene), poly(propyl acrylate-butadiene), poly(butyl acrylate-butadiene), poly(styrene-isoprene), poly(methylstyrene-isoprene), poly(methyl methacrylate-isoprene), poly(ethyl methacrylate-isoprene), poly(propyl methacrylate-isoprene), poly(butyl methacrylateisoprene), poly(methyl acrylate-isoprene), poly(ethyl acrylate-isoprene), poly(propyl acrylate-isoprene), poly(butyl acrylate-isoprene), poly(styrene-butylacrylate), poly(styrene-butadiene), poly(styrene-isoprene), poly(styrene-butyl methacrylate), poly(styrene-butyl acrylate-acrylic acid), poly(styrene-butadiene-acrylic acid), poly(styrene-isoprene-acrylic acid), poly(styrene-butyl methacrylate-acrylic acid), poly(butyl methacrylate-butyl acrylate), poly(butyl methacrylate-acrylic acid), poly(styrene-butyl acrylate-acrylonitrile-acrylic acid), poly(acrylonitrile-butyl acrylate-acrylic acid), and combinations thereof.

The resins described above may be utilized to form toner compositions. Such toner compositions may include optional colorants, optional, and other additives.

Toners may be formed utilizing any method within the purview of those skilled in the art. In embodiments, the toner herein can be formed by a process comprising homogenizing the resin emulsion with a surfactant, an optional colorant, an optional wax, and an optional coagulant to form a homogenized toner slurry comprising pre-aggregated particles at room temperature; heating the slurry to form aggregated toner particles; optionally freezing the toner slurry once at the desired aggregated particle size; and further heating the aggregated particles in the slurry to coalesce the aggregated particles into toner particles. Alternately, the toners are conventional toners prepared by combination, pulverizing, grinding, and classification processes.

Colorant.

The toner may optionally include a colorant selected from the group consisting of dyes, pigments, and combinations thereof, alone or in combination with a metallic colorant. In embodiments, the toner includes a metallic colorant, in embodiments, a metallic pigment. In embodiments, the toner comprises a metallic colorant including a metal comprising a member selected from the group consisting of aluminum, gold, silver, zinc, platinum, chromium, titanium, copper-zinc alloys, and combinations thereof.

In embodiments, toner includes a metallic pigment selected from the group consisting of aluminum, zinc, copper-zinc alloys, and combinations thereof. In a specific embodiment, the metallic pigment comprises aluminum flake.

In embodiments, the toner is free of additional colorant, that is, the toner does not contain, any colorant other than the metallic pigment.

The metallic pigment can be present in any suitable or desired amount. In embodiments, the metallic pigment is present in an amount of from about 0.1 to about 10 percent, or from about 1 to about 8 percent, or from about 2 to about 6 percent by weight, based on the total weight of the toner composition.

Insulative Surface Additives.

In embodiments, the toner includes an insulative surface additive. The insulative surface additive can be disposed over the metallic pigment that is bonded to the toner.

Any suitable or desired insulative surface additive can be selected. In embodiments, the insulative surface additive is selected from the group consisting of mineral oil, long chain fatty acids, and silicone oil. In a specific embodiment, the insulative surface additive is silicone oil. In embodiments, long chain fatty acids are fatty acids having aliphatic carbon tails having from about 13 to about 21 carbon atoms, or longer aliphatic carbon tails having about 22 carbon atoms or more.

The insulative surface additive can be provided in any suitable or desired amount. In embodiments, the insulative surface additive is present in an amount of from about 0.1 to about 2 percent, or from about 0.5 to about 1.5 percent, or from about 0.15 to about 0.3 percent by weight, based on the total weight of the toner.

Surface Additives.

The toner composition of the present embodiments may include one or more surface additives in addition to the insulative surface additive. The surface additives are coated onto the surface of the toner particles, which may provide a total surface area coverage of from about 50% to about 99%, from about 60% to about 90%, or from about 70% to about 80% of the toner particle. The toner composition of the present embodiment may include from about 2.7% to about 4.0%, from about 3.0% to about 3.7%, or from about 3.1% to about 3.5% of surface additive based on the total weight on the toner.

The surface additives may include silica, titania and stearates. The charging and flow characteristics of a toner are influenced by the selection of surface additives and concentration of such in the toner. The concentration of surface additives and their size and shape control the arrangement of these on the toner particle surface. In embodiments, the silica includes two coated silicas. More specifically, one of the two silicas may be a negative charging silica, and the other silica may be a positive charging silica (relative to the carrier). By negatively charging is meant that the additive is negatively charging relative to the toner surface measured by determining the toner triboelectric charge with and without the additive. Similarly, by positively charging is meant that the additives are positively charging relative to the toner surface measured by determining the toner triboelectric charge with and without the additive.

An example of the negative charging silica include NA50HS obtained from DeGussa/Nippon Aerosil Corporation, which is a fumed silica coated with a mixture of hexamethyldisilazane and aminopropyltriethoxysilane (having approximately 30 nanometers of primary particle size and about 350 nanometers of aggregate size).

An example of the relatively positive charging silica include H2050 silica with polydimethylsiloxane units or segments, and having amino/ammonium functions chemically bonded onto the surface of highly hydrophobic fumed silica, and which coated silica possesses a BET surface area of about 110 to about ±20 m²/g (obtained from Wacker Chemie).

The negative charging silica may be present in an amount from about 1.6% to about 2.4%, from about 1.8% to about 2.2%, from about 1.9% to about 2.1%, by weight of the surface additives.

The positive charging silica may be present in an amount from about 0.08% to about 1.2%, from about 0.09% to about 0.11%, from about 0.09% to about 0.1%, by weight of the surface additives.

The ratio of the negatively charging silica to the positively charging silica ranges from, for example, about 13:1 to about 30:1, or from about 15:1 to about 25:1, weight basis.

The surface additives may also include a titania. The titania may be present in an amount from about 0.53% to about 0.9%, from about 0.68% to about 0.83%, from about 0.7% to about 0.8%, by weight of the surface additives. A suitable titania for use herein is, for example, SMT5103 available from Tayca Corp., a titania having a size of about 25 to about 55 nm treated with decylsilane.

The weight ratio of the negative charging silica to the titania is from about 1.8:1 to about 4.5:1, from about 2.2:1 to about 3.2:1, or from about 2.5:1 to about 3.0:1.

The surface additives may also include a lubricant and conductivity aid, for example a metal salt of a fatty acid such as, e.g., zinc stearate, calcium stearate. A suitable example includes Zinc Stearate L from Ferro Corp., or calcium stearate from Ferro Corp. Such a conductivity aid may be present in an amount from about 0.10% to about 1.00% by weight of the toner.

In another preferred embodiment, the toner and/or surface additive also includes a conductivity aid, for example a metal salt of a fatty acid such as, e.g., zinc stearate. A suitable example includes Zinc Stearate L from Ferro Corp. Such a conductivity aid may be present in an amount from about 0.10% to about 1.00% by weight of the toner.

The developer compositions can be prepared by mixing the toners with the carrier particles described herein.

The carriers may be present in any suitable or desired amount, in embodiments, from about 2 percent by weight of the toner to about 8 percent by weight of the toner, in embodiments from about 4 percent by weight to about 6 percent by weight of the toner.

### EXAMPLES

The following Examples are being submitted to further define various species of the present disclosure. These Examples are intended to be illustrative only and are not intended to limit the scope of the present disclosure. Also, parts and percentages are by weight unless otherwise indicated.

Preparation of the following examples included the steps as follows.

1. Mixing the polymer at the desired coating weight, in embodiments, 0.8 to 1.2 pph) with atomized steel core of 78 micrometers average diameter (as determined by laser diffraction) using M5R or other appropriately sized blender.

2. Processing the core-polymer mixture on a rotary kiln at 0.4 degree angle, 6 rpm, kiln temperature 450° F. (product temperature 400 to 420° F.).

3. Testing bench properties (tribo, conductivity, VB, particle size, bulk density, mass flow) using documented test methods.

4. Making a developer blend at 4.5 pph (parts per hundred) target using M5R blender at 220 rpm.

Power coated carriers were prepared with different polymers for evaluation with silver toner. The polymers were polymethyl methacrylate polymers available under the names Soken MP-116, SLS-PMMA, available from Xerox Research Center of Canada, MP-2800, and MP2800HM01 from Soken Chemical of Japan. Properties of the polymers used in the Examples below are shown in Table 1.

TABLE 1

| | Molecular Weight (Mw) | Particle Size |
|---|---|---|
| Polymer | (×1,000) | (micrometers) |
| Soken MP-116 | 300-600 | 0.3-0.6 |
| SLS-PMMA | 400-600 | 0.07-0.1 |
| MP-2800 | 150 | 0.1-0.25 |
| MP2800HM01 | 1300 | 0.1--/25 |

Several carrier formulations with different polymers were prepared for evaluation with silver toner. Comparative Example 1 and Examples 2-7 each prepared with a carrier core comprising atomized steel core of 78 micrometers average diameter available from North American Hoganas were prepared with the polymer coating compositions shown in Table 2 below.

TABLE 2

| Carrier Example | Polymer Coating (pph) |
|---|---|
| Comparative Example 1 | Soken MP-116 (1.) |
| 2 | SLS-PMMA (1.0) |
| 3 | MP-2800 (0.8) |
| 4 | MP-2800 (0.8) |
| 5 | MP-2800 (1.2) |
| 6 | MP-2800 (1.2) |
| 7 | MP2800HM01 (1.0 |

Core-polymer mixing conditions for Comparative Example 1 and Examples 2-7 are shown in Table 3. In Table 3, “Cwt”=“Coating weight”. “Cwt % (TGA)” is the coating weight, as determined by thermogravimetric analysis.

TABLE 3

| | | | | Kiln | Cwt | | |
|---|---|---|---|---|---|---|---|
| Carrier | | | M5R | Temperature | Target | Cwt % | % Average |
| Example | Kiln | Tg (° C.) | (rpm) | (° F.) | (pph) | (TGA) | Coverage |
| Comparative | 16″ | 120 | na | — | 1.0 | — | — |
| Example 1 | | | | | | | |
| 2 | 3 | 116 | 220 | 450 | 1.0 | 0.9 | 94 ± 1 |
| 3 | 3 | 112-116 | 220 | 450 | 0.8 | 0.75 | 98 ± 1 |
| 4 | 3 | 112-116 | 415 | 450 | 0.8 | 0.76 | 96 ± 2 |
| 5 | 3 | 112-116 | 220 | 450 | 1.2 | 1.1 | 99 ± 0 |
| 6 | 3 | 112-116 | 415 | 450 | 1.2 | 1.2 | 97 ± 1 |
| 7 | 3 | 114 | 220 | 450 | 1.0 | 0.95 | 98 ± 1 |

Example 8. A silver toner [FX-RY50] was prepared as follows. 75 grams of silver particles (Particle iD# EAT-600S sourced from Fuji Xerox) were added to a benchtop blender, followed by addition of 3.5% by weight of silica additive RY50 (avanilable from Nippon Aerosil), 1.6% of titania additive SMT5103 (available from Tayca Corporation), 0.5% of zinc stearate additive (available from Ferro Corporation) and 0.1% of silica additive H2050EP (available from Wacker Chemie). The contents were then blended at approximately 15,000 rpm for 2.5 minutes to give the final blended toner called FX-RY50 herein.

Example 9. A silver toner [TB-33328-3] was prepared as follows. 4 pounds of silver particles (Particle iD# EAT-600S sourced from Fuji Xerox) were added to a 10L Henschel Vertical Mixer, followed by addition of 3.5% by weight of silica additive RY50 (avanilable from Nippon Aerosil), 1.6% of titania additive SMT5103 (available from Tyca Corporation), 0.5% of zinc stearate additive (available from Ferro Corporation) and 0.1% of silica additive H2050EP (available from Wacker Chemie). The contents were then blended at approximately 2048 rpm for 4 minutes followed by screening through a 37 micron sieve screener to give the final blended toner called TB-33328-3 herein.

Example 10. A silver toner [FXS-33238-1 or -2] was prepared in the same manner as TB 33238-3 in Example 9. These were repeat materials assigned different identifications to distinguish between materials made at different times.

The carriers of Comparative Example 1 and Examples 1-7 were evaluated with the silver toners of Example 8 and Example 9. Results are shown in Table 4.

TABLE 4

| Carrier | | Tribo | Tribo | | | |
|---|---|---|---|---|---|---|
| Coating | Silver Toner | Corrected | Corrected | Tribo (silver | Conductivity | |
| Example | Example | (iGen K) | (iGen C) | toner) | at 30 V | VB |
| Comparative | 8 | 34.9 | 34.8 | 28.5 | 9.88 | 110.8 |
| Example 1 | | | | | | |
| 2 | 8 | 41.1 | 38.8 | 44.8 | 11.61 | 72.2 |
| 3 | 8 | 42.8 | 43.8 | 50.2 | 13.34 | 291.4 |
| 4 | 8 | 42.2 | 42.8 | 49.1 | 13.55 | 179.6 |
| 5 | 8 | 40.9 | 44.6 | 50.4 | 13.45 | 436.0 |
| 6 | 9 | 42.5 | 44.6 | 52.0 | 13.75 | 252.8 |
| 7 | 10 | 33.8 | 38.6 | 40.8 | 13.78 | 1442.6 |

iGen K: A commercially available black toner such as Xerox ® iGen Black Toner 6R1350.
iGen C: A commercially available cyan toner such as Xerox ® iGen Cyan Toner 6R1351.

The carriers of Examples 3, 4, and 6 having the highest tribo with conventional toners “iGen K” and “iGen C” were evaluated with the silver toner formulation of Example 8 as shown in Table 4 and found to have an unexpectedly higher tribo, while the Comparative carriers of Example 1 and Example la had an unexpectedly lower tribo. The tribo difference between the Comparative Examples 1 and la and the Examples 3, 4, and 5 illustrating the present embodiments was about 20 μC/g with the silver toner of Example 8.

MP-2800 PMMA has a lower molecular weight than Soken MP-116 PMMA and SLS-PMMA, and a smaller particle size than Soken MP-116 PMMA. Without wishing to be bound by theory, it is believed that the smaller particle size MP-2800 PMMA flows more uniformly during the powder coating process, coating more of the core and resulting in a higher tribo. It was surprisingly found that the combination of a low molecular weight polymer and a smaller particle size resulted in a higher tribo. The carrier of Example 7 having the small particle size, high molecular weight PMMA did not have as high a tribo.

The carrier of Example 5 having MP-2800 PMMA at 1.2 pph coating weight was evaluated with the silver toner of Example 9 in a Xerox® iGen 5 Digital Press and found to have a higher tribo than that of nominal carrier iGen Universal Developer, commercially available as Universal Developer 505S00005 from Xerox Corporation as shown in Table 5.

TABLE 5

| Carrier Composition | In-Machine TC | In-Machine Tribo (μC/g) |
|---|---|---|
| iGen Nominal | 5.4 | 20-25 |
| Example 5 - high tribo | 5.4 | 37 |
| carrier | | |

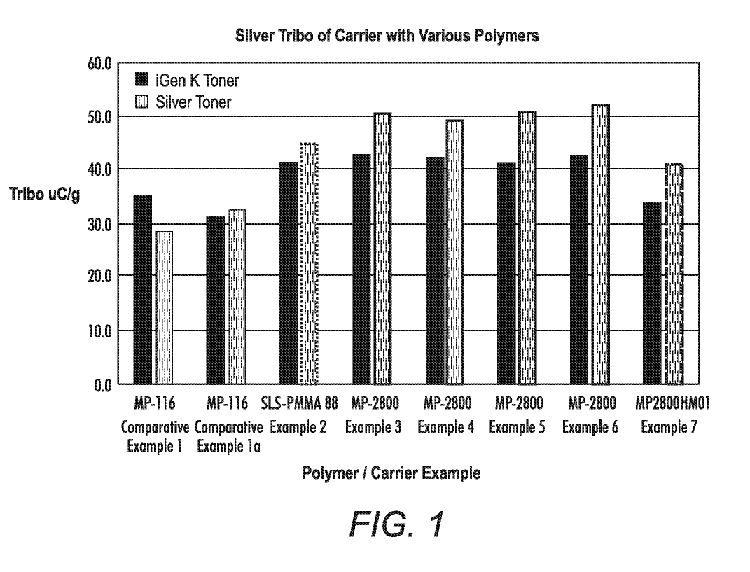

FIG. 1 illustrates silver toner tribo of carriers with various polymers. Tribo in μC/g for silver toner with carrier of Comparative Example 1, Example 5, Example 2, Example 6 and Example 7 are shown along with results for iGen K Toner [Xerox® iGen Black Toner 6R1350].

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims. Unless specifically recited in a claim, steps or components of claims should not be implied or imported from the specification or any other claims as to any particular order, number, position, size, shape, angle, color, or material.

1. A carrier comprising:
a carrier core; and
a coating thereover;
wherein the coating comprises a polymethyl methacrylate polymer having a low molecular weight of from about 125,000 to about 175,000 g/mole and a particle size of less than about 0.3 micrometer.

2. The carrier of claim 1, wherein the carrier core is selected from the group consisting of granular zircon, granular silicon, glass, steel, nickel, ferrites, magnetites, iron ferrites, silicon dioxide, and combinations thereof.

3. The carrier of claim 1, wherein the carrier core comprises a steel core.

4. The carrier of claim 1, wherein the coating polymer is selected from the group consisting of polymethyl methacrylate, copoly-trifluoroethyl-methacrylate-methyl methacrylate, polyvinylidene fluoride, polyvinylfluoride copolybutylacrylate methacrylate, copoly perfluorooctylethylmethacrylate methylmethacrylate, polystyrene, a copolymer of trifluoroethyl-methacrylate and methylmethacrylate, and combinations thereof.

5. (canceled)

6. The carrier of claim 1, wherein the polymethyl methacrylate polymer has a low molecular weight of 150,000 g.

7. The carrier of claim 1, wherein the carrier core comprises a steel core.

8. The carrier of claim 1, wherein the coating thereover is provided at a coating weight of from about 0.8 pph to about 1.2 pph.

9. A developer comprising:
a toner; and
a carrier;
wherein the carrier comprises:
a carrier core; and
a coating thereover;
wherein the coating comprises a polymethyl methacrylate polymer having a low molecular weight of from about 125,000 to about 175,000 g/mole and a particle size of less than about 0.3 micrometer .

10. The developer of claim 9, wherein the carrier core is selected from the group consisting of granular zircon, granular silicon, glass, steel, nickel, ferrites, magnetites, iron ferrites, silicon dioxide, and combinations thereof.

11. The developer of claim 9, wherein the polymethyl methacrylate polymer has a low molecular weight of about 150,000 g/mole and an average particle size of about 0.1 to about 0.25 micrometer.

12. The developer of claim 9, wherein the toner comprises a metallic pigment.

13. The developer of claim 9, wherein the toner comprises a metallic colorant including a metal comprising a member selected from the group consisting of aluminum, gold, silver, zinc, platinum, chromium, titanium, copper-zinc alloys, and combinations thereof.

14. A process for preparing a carrier comprising:
providing a carrier core; and
disposing a polymer coating thereover by combining the carrier core and the polymer coating in a mixing device;
optionally, fusing the coating to the carrier core;
wherein the coating comprises a polymer having a low molecular weight of from about 125,000 to about 175,000 g/mole and a particle size of less than about 0.3 micrometer.

15. The process of claim 14, wherein combining the carrier core and the polymer coating in the mixing device is accomplished using high intensity mixing of from about 300 to about 450 revolutions per minute, medium intensity mixing of from about 150 to about 250 revolutions per minute, or a combination thereof.

16. The process of claim 14, wherein combining the carrier core and the polymer coating in the mixing device is accomplished using high intensity mixing of from about 300 to about 450 revolutions per minute.

17. The process of claim 14, wherein the coating thereover is provided at a coating weight of from about 0.5 pph to about 1.5 pph.

18. The process of claim 14, wherein the carrier core is selected from the group consisting of granular zircon, granular silicon, glass, steel, nickel, ferrites, magnetites, iron ferrites, silicon dioxide, and combinations thereof.

19. The process of claim 14, wherein polymethyl methacrylate has a low molecular weight of from about 150,000 g/mole.

20. The process of claim 14, wherein the carrier core comprises a steel core.

21. A carrier comprising:
a carrier core; and
a coating thereover;
wherein the coating comprises polymethyl methacrylate having a low molecular weight of about 150,000 g/mole and an average particle size of about 0.1 to about 0.25 micrometer.
